(19) United States
(12) Patent Application Publication
(10) Pub. No.: US 2007/0188387 A1
(43) Pub. Date: Aug. 16, 2007

(54) Device comprising an antenna for exchanging radio frequency signals

(75) Inventor: Anthony Kerslaers, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,720

(22) PCT Filed: May 9, 2005
(86) PCT No.: PCT/IB05/51492

§ 371 Date: Nov. 6, 2006

(30) Foreign Application Priority Data
May 12, 2004 (EP) 04102048.8

(51) Int. Cl. H01Q 1/38

(52) U.S. Cl. 343/700 MS

(57) ABSTRACT

Relatively small omnidirectional antennas (2,3) with sufficient antenna impedance for exchanging radio frequency signals are provided with two parallel elements (21,22) coupled to each other via their outer ends. Each element (21,22) comprises two subelements (23,24,25,26) separated by a gap (27,28). The elements (21,22) have lengths smaller than half the wavelength of the radio frequency signals. The antennas (2,3) do not need to be operated against a ground surface, and can be used in a non-horizontal position. The elements (21,22) are planar elements. The antennas (2,3) further comprise two further elements (41,42) located in a plane parallel to a plane of the elements (21,22). This increases the impedance and improves the return loss of the antennas (2,3). One of the further elements (41) comprises two sub-elements (43,44) separated by a gap (47), to realise a simulated return loss with one dip. Alternatively, the other further element (42) comprises a gap, to realise a simulated return loss with two dips for dual-band environment.

The invention relates to a device comprising an antenna for exchanging radio frequency signals with an other device, and also relates to an antenna, and to a method.

Examples of such a device are home theatre devices, surround sound devices, wireless headphone devices, second room wireless audio devices, mobile terminals and wireless interfaces.

A prior art antenna is known from JP 2002-271118, which discloses an antenna unit with a passive element. The passive element is capable of suppressing a radiation of radio waves in a prescribed direction. In other words, this antenna unit is not an omnidirectional antenna.

The known antenna is disadvantageous, inter alia, owing to the fact that it is not an omnidirectional antenna. Omnidirectional antennas are known, of course, such as for example prior art dipole antennas. A dipole antenna is in resonance at half a wavelength. For example at 864 MHz in open air, this corresponds with approximately 16 cm, which is relatively large. When reducing the length of the prior art dipole antenna, it gets a decreased antenna impedance. This decreased antenna impedance can be matched by means of a disadvantageous matching circuit. In case of not being matched, the decreased antenna impedance results in a poor electrical efficiency and in a poor return loss (large reflections).

It is an object of the invention, inter alia, to provide a device comprising a relatively small omnidirectional antenna having a sufficient antenna impedance.

Furthers objects of the invention are, inter alia, to provide a relatively small omnidirectional antenna having a sufficient antenna impedance, and a method for use in combination with a relatively small omnidirectional antenna having a sufficient antenna impedance.

The device according to the invention comprises an antenna for exchanging radio frequency signals with an other device, which antenna comprises two elements, first outer ends of the elements being coupled to each other and second outer ends of the elements being coupled to each other, each element comprising two sub-elements separated by a gap, the elements having lengths smaller than half the wavelength of the radio frequency signals.

This antenna has a length smaller than half the wavelength of the radio frequency signals. Therefore the antenna is relatively small. The shape of the antenna results in an omnidirectional antenna pattern and in the antenna having a sufficient antenna impedance. This antenna is further advantageous in that it does not require a matching network, does not require the power amplifier to be overdimensioned, and does not introduce extra power consumption. The antenna can be used for transmitting as well as for receiving radio frequency signals.

It should be noted that shorter prior art dipole antennas exist, which shorter dipole antennas are brought in resonance with two loading coils. These prior art dipole antennas themselves do not have a sufficient antenna impedance and require disadvantageous matching circuits.

The device for example further comprises an integrated wireless audio solution comprising an integrated wireless audio radio ic and an integrated wireless audio base band processor. The radio frequency signals are for example situated between 850 MHz and 950 MHz.

An embodiment of the device according to the invention is defined by the elements being parallel elements, the length of an element having a value between 40% and 80% of half the wavelength of the radio frequency signals and a width of an element having a value between 0.1% and 20% of the length, a gap distance of an element having a value smaller than 20% of the length, and an element distance between the parallel elements having a value between 0.1% and 20% of the length. Under these conditions, the antenna performs best.

An embodiment of the device according to the invention is defined by the antenna not operating against a ground surface. Such a ground surface used to act as an image for the antenna. This allows the antenna to be used in a non-horizontal position and reduces the space necessary for the antenna. The antenna can be used in a vertical position, and it can be mounted on the backside of for example a television receiver.

An embodiment of the device according to the invention is defined by the elements being planar elements, the outer ends of the elements being coupled to each other via other planar elements. Such an antenna is easy to integrate.

An embodiment of the device according to the invention is defined by the antenna comprising two further elements, first outer ends of the further elements being coupled to each other and second outer ends of the further elements being coupled to each other, the further elements having lengths smaller than half the wavelength of the radio frequency signals. The introduction of the two further elements for example located in a plane parallel to a plane of the elements (further) increases the antenna impedance and, as a result, improves the return loss of the antenna. This is especially of importance when using the antenna for receiving radio frequency signals.

An embodiment of the device according to the invention is defined by the two elements being planar elements printed on a first side of a circuit board and the two further elements are further planar elements printed on a second side of the circuit board. Such an antenna is easy to integrate. The circuit board isolates the pairs of elements from each other electrically.

An embodiment of the device according to the invention is defined by the elements being parallel elements and the further elements being parallel further elements, the length of an element having a value between 40% and 80% of half the wavelength of the radio frequency signals and a width of an element having a value between 0.1% and 20% of the length, a gap distance of an element having a value smaller than 20% of the length, an element distance between the parallel elements and between the parallel further elements having a value between 0.1% and 20% of the length, a thickness of the elements having a value equal to or smaller than 10% of the width, and the circuit board comprising a substrate material with a thickness having a value equal to or smaller than the width. Under these conditions, the antenna having an increased antenna impedance performs best.

An embodiment of the device according to the invention is defined by one of the further elements comprising two sub-elements separated by a gap diagonally opposite to a feeding gap of the elements, the other further element being without a gap. This antenna has a normal simulated return loss with one dip.

An embodiment of the device according to the invention is defined by a gap distance of the gap between the two sub-elements of the further element having a value smaller than 20% of at least one length. Under this condition, the antenna having an increased antenna impedance performs best.

An embodiment of the device according to the invention is defined by one of the further elements comprising two sub-elements separated by a gap non-diagonally opposite to a feeding gap of the elements, the other further element being without a gap. This antenna has a normal simulated return loss with two dips. Such an antenna can for example be used advantageously in a dual-band environment at GSM/UMTS frequencies and at WLAN frequencies such as for example 2.5 GHz and 5.2 GHz.

Embodiments of the antenna according to the invention and of the method according to the invention correspond with the embodiments of the device according to the invention.

The invention is based upon an insight, inter alia, that a prior art dipole antenna is either relatively large or has an insufficient antenna impedance in case its length is reduced, and is based upon a basic idea, inter alia, that a relatively small antenna having a sufficient antenna impedance can be made out of two elements, by coupling first outer ends of the elements to each other and by coupling second outer ends of the elements to each other, whereby each element comprises two sub-elements separated by a gap. .

The invention solves the problem, inter alia, to provide a device comprising a relatively small omnidirectional antenna having a sufficient antenna impedance, and is advantageous, inter alia, in that the antenna does not require a matching network, does not require the power amplifier to be overdimensioned, and does not introduce extra power consumption. The antenna can be used for transmitting as well as for receiving radio frequency signals.

These and other aspects of the invention will be apparent from and elucidated with reference to the embodiments(s) described hereinafter.

In the drawings:

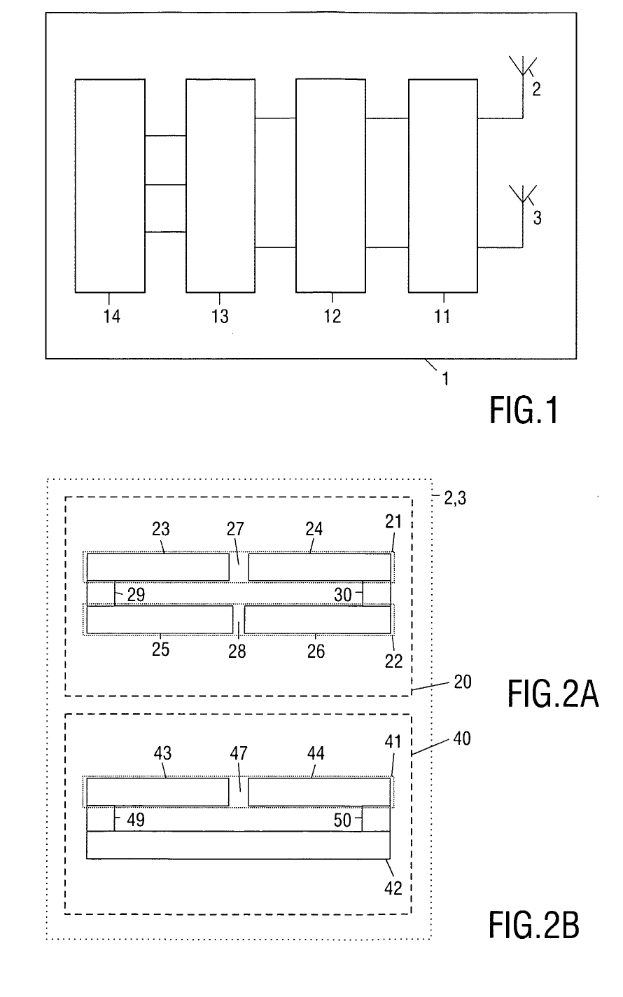

FIG. 1 shows diagrammatically a device according to the invention comprising an antenna according to the invention;

FIG. 2 shows diagrammatically an antenna according to the invention in greater detail with a top side (2A) and bottom side (2B);

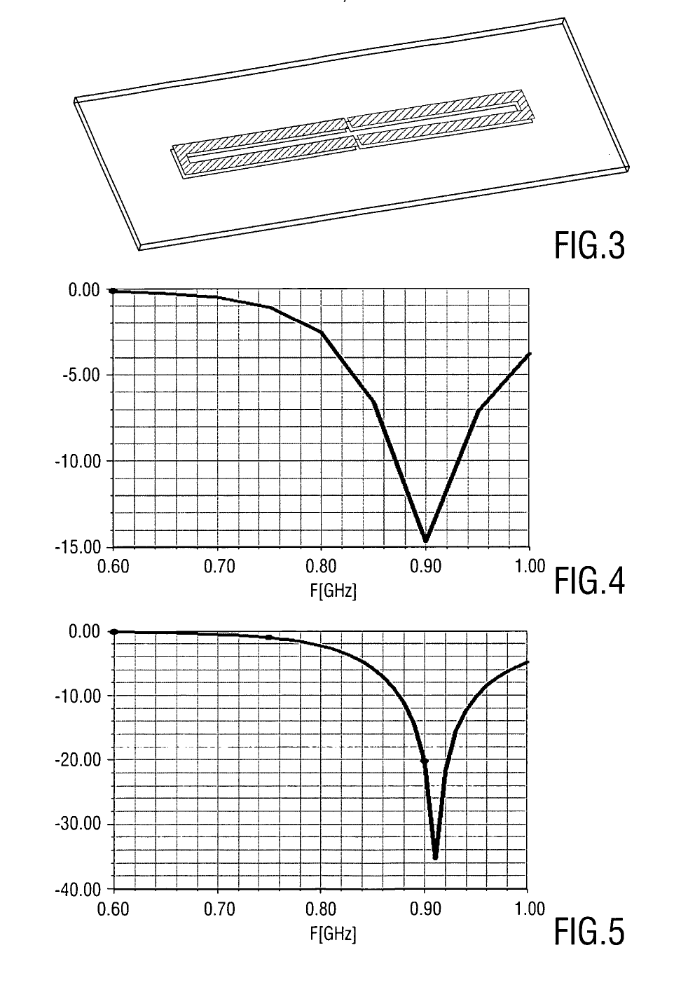

FIG. 3 shows a three-dimensional view of the antenna according to the invention;

FIG. 4 shows a simulated return loss for a prior art dipole antenna operating at 900 MHz;

FIG. 5 shows a simulated return loss for a prior art dipole antenna on a printed circuit board operating at 900 MHz;

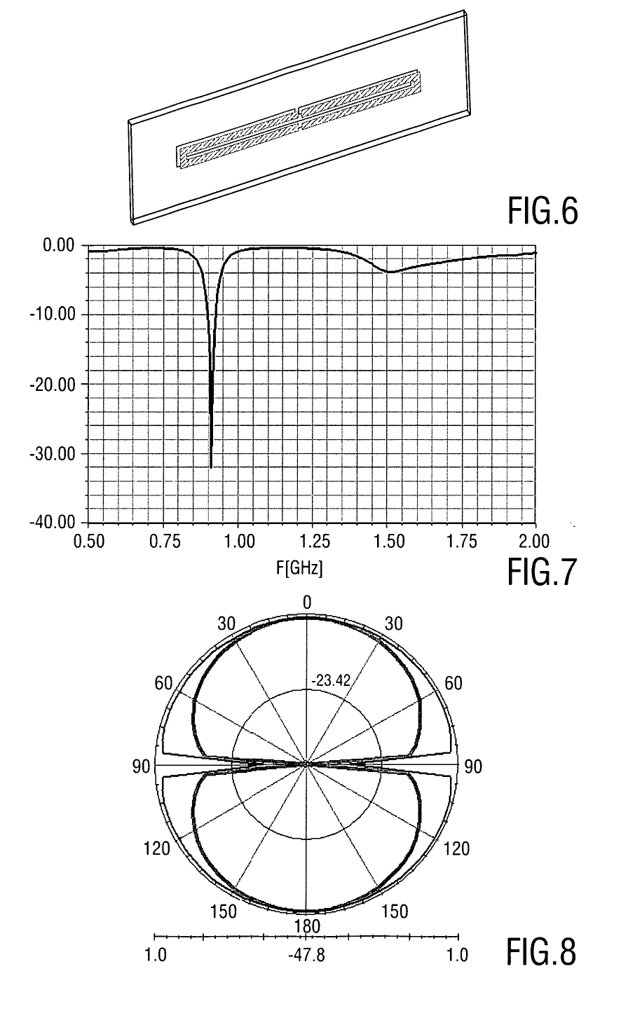

FIG. 6 shows a three-dimensional view of the antenna according to the invention for 915 MHz;

FIG. 7 shows a simulated return loss for the antenna according to the invention for 915 MHz;

FIG. 8 shows a simulated radiation pattern for the antenna according to the invention for 915 MHz;

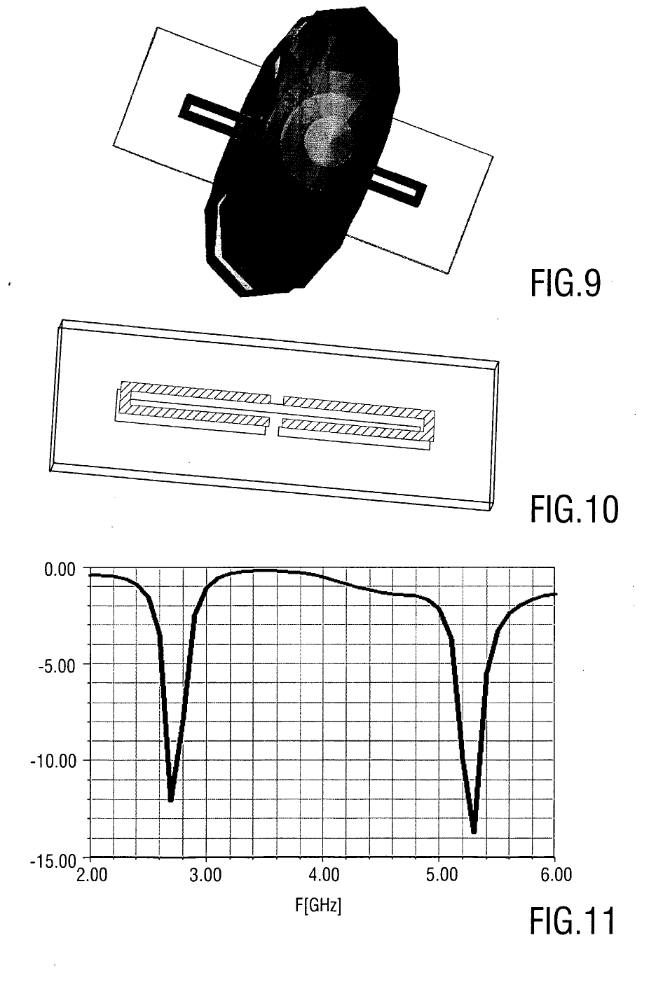

FIG. 9 shows a simulated three-dimensional radiation pattern for the antenna according to the invention for 915 MHz;

FIG. 10 shows a three-dimensional view of the antenna according to the invention for dual-band operation at 2.5 GHz and 5.2 GHz;

FIG. 11 shows a simulated return loss for the antenna according to the invention for dual-band operation at 2.5 GHz and 5.2 GHz;

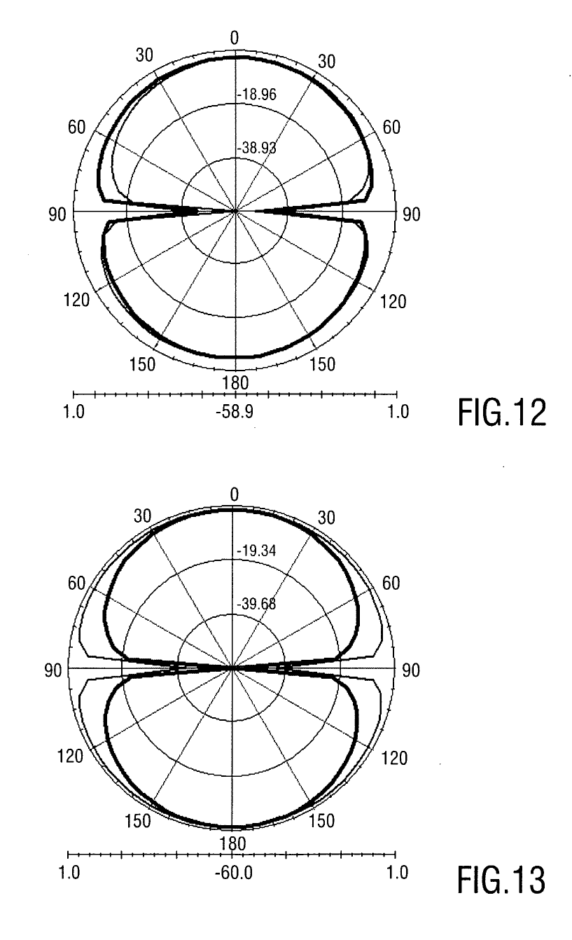

FIG. 12 shows a simulated radiation pattern for the antenna according to the invention for dual-band operation at 2.5 GHz; and

FIG. 13 shows a simulated radiation pattern for the antenna according to the invention for dual-band operation at 5.2 GHz;

The device 1 according to the invention shown in FIG. 1 comprises antennas 2,3 according to the invention for exchanging radio frequency signals with an other device. not shown. The antennas 2,3 are coupled to a filtering/switching circuit 11. The circuit 11 is coupled via integrated wireless audio solution circuits 12,13 comprising an integrated wireless audio radio ic circuit 12 and an integrated wireless audio base band processor circuit 13 to an interface 14. In a transmitting mode, the interface 14 is coupled to or forms a source, such as for example a microphone, a computer, a player etc. Source signals flow via the circuits 13,12,11 to one or more of the antennas 2,3. In a receiving mode, destination signals arrive via one or more of the antennas 2,3 and flow via the circuits 11,12,13 to the interface 14. The interface 14 is coupled to or forms a destination, such as for example a loudspeaker, a computer, a recorder etc. The device 1 for example comprises (a part of) a home theatre system, (a part of) a surround sound system, (a part of) a wireless headphone system, (a part of) a second room wireless audio system, a mobile terminal, a wireless interface etc.

The antenna 2 (and/or 3) according to the invention shown in FIG. 2 comprises, on a top side of for example a printed circuit board, two elements 21,22 such as for example planar elements. First outer ends of the elements 21,22 are coupled to each other via for example an other planar element 29 and second outer ends of the elements 21,22 are coupled to each other via for example an other planar element 30. The element 21 (22) comprises two sub-elements 23,24 (25,26) separated by a gap 27 (28). The elements 21,22 have lengths smaller than half the wavelength of the radio frequency signals.

Usually, the input of the antenna 2,3 in a transmitting mode and the output of the antenna 2,3 in a receiving mode are formed by the outer ends of the sub-elements 25,26 located closest to the (feeding) gap 28. Therefore, this (feeding) gap 28 will have a relatively small gap distance. The gap distance of the gap 27 may be larger, up to a border value defined below. The element 22 is an active element, and the element 21 is a passive element.

The antenna 2 (and/or 3) may further comprise, on a bottom side of for example the printed circuit board, two further elements 41,42, such as for example planar elements. First outer ends of the further elements 41,42 are coupled to each other via for example an other planar element 49 and second outer ends of the further elements 41,42 are coupled to each other via for example an other planar element 50. The further element 41 comprises two sub-elements 43,44 separated by a gap 47. The further element 42 does not have a gap. Alternatively, the further element 41 does not have a gap, in which case the further element 42 will have a gap. The further elements 41,42 have lengths smaller than half the wavelength of the radio frequency signals and will usually be passive elements.

Preferably, the elements 21,22 are parallel elements and the further elements 41,42 are parallel further elements. The length of an element 21,22,41,42 has a value between 40% and 80% of half the wavelength of the radio frequency signals and a width of an element 21,22,41,42 has a value between 0.1% and 20% of the length. A gap distance of a gap 27,28,47 has a value smaller than 20% of the length. An element distance between the parallel elements 21,22 and between the parallel further elements 41,42 has a value between 0.1% and 20% of the length. A thickness of the elements 21,22,41,42 has a value equal to or smaller than 10% of the width, and the circuit board comprises a substrate material with a thickness having a value equal to or smaller than the width.

According to prior art antenna theories, the element distance between the parallel elements 21,22 and between the parallel further elements 41,42 should be for example a quarter of a wavelength. However, according to the invention, this element distance should preferably have a value much smaller than a quarter of a wavelength, such as for example approximately the width of an element 21,22,41,42.

The antenna 2,3 has a length smaller than half the wavelength of the radio frequency signals. Therefore the antenna 2,3 is relatively small. The shape of the antenna 2,3 results in an omnidirectional antenna pattern and in the antenna 2,3 having sufficient antenna impedance. The radio frequency signals are for example situated between 850 MHz and 950 MHz. The antenna 2,3 does not need to be operated against a ground surface. This allows the antenna 2,3 to be used in a non-horizontal position such as for example a vertical position and reduces the space necessary for the antenna 2,3. The antenna 2,3 can be mounted on the backside of a device 1 in the form of for example a television receiver.

The introduction of the two further elements 41,42 for example located in a plane parallel to a plane of the elements 21,22 (further) increases the impedance. As a result, the return loss of the antenna 2,3 is improved. This is of importance when using the antenna 2,3 for receiving radio frequency signals. The antenna 2,3, in case of its further element 41 comprising two sub-elements 43,44 separated by a gap 47 diagonally opposite to the (feeding) gap 28, has a normal simulated return loss with one dip, as shown in FIG. 7. In case of its further element 41 not comprising a gap and its further element 42 comprising a gap non-diagonally opposite to the (feeding) gap 28, the antenna 2,3 has a normal simulated return loss with two dips, as shown in FIG. 11. Such an antenna 2,3 can for example be used advantageously in a dual-band environment at GSM/UMTS frequencies and at WLAN frequencies such as for example 2.5 GHz and 5.2 GHz.

In case of the length of the elements 21,22,41,42 corresponding with the x-axis and the width of the elements 21,22,41,42 corresponding with the y-axis, the x,y plane of the elements 21,22 and the x,y plane of the elements 41,42 will be substantially parallel planes. The thickness of the elements 21,22,41,42 and the thickness of the substrate material will then correspond with the z-axis. Each one of these planes will have a substantially different location on the z-axis. Usually, the x,y sizes and the x,y coordinates of the elements 21,22 in one of the planes will substantially correspond (less than 20% difference) with the x,y sizes and the x,y coordinates of the elements 41,42 in the other plane.

In FIG. 3, a three-dimensional view of the antenna 2,3 according to the invention is shown.

In FIG. 4, a simulated return loss for a prior art dipole antenna operating at 900 MHz is shown, in dB (y-axis) versus GHz (x-axis). This prior art dipole antenna comprises two serial parts each having a length of approximately 80 mm.

FIG. 5 shows a simulated return loss for a prior art dipole antenna on a printed circuit board operating at 900 MHz, in dB (y-axis) versus GHz (x-axis). This prior art dipole antenna comprises two serial elements each having a length of approximately 62 mm and a width of 1 mm.

In FIG. 6, a three-dimensional view of the antenna 2,3 according to the invention for 915 MHz is shown. Thereby, elements 21,22,41,42 have a length of 38 mm, a width of 2.5 mm, a element distance of 2.5 mm, with a substrate material having a thickness of 1.6 mm and with the copper having a thickness of 0.035 mm.

In FIG. 7, a simulated return loss for the antenna according to the invention of FIG. 6 is shown, in dB (y-axis) versus GHz (x-axis).

In FIG. 8, a simulated radiation pattern for the antenna according to the invention of FIG. 6 is shown.

In FIG. 9, a simulated three-dimensional radiation pattern for the antenna according to the invention of FIG. 6 is shown.

In FIG. 10, a three-dimensional view of the antenna according to the invention for dual-band operation at 2.5 GHz and 5.2 GHz is shown. Thereby, elements 21,22,41,42 have a length of 12 mm, a width of 1 mm, a element distance of 1 mm, with a substrate material having a thickness of 1.6 mm and with the copper having a thickness of 0.035 mm.

In FIG. 11, a simulated return loss for the antenna according to the invention of FIG. 10 is shown, in dB (y-axis) versus GHz (x-axis). The second dip results from the fact that in this case the the further element 41 is gap-less, with the further element 42 now comprising a gap.

In FIG. 12, a simulated radiation pattern for the antenna according to the invention of FIG. 10 is shown.

In FIG. 13, a simulated radiation pattern for the antenna according to the invention of FIG. 10 is shown.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. Device (1) comprising an antenna (2,3) for exchanging radio frequency signals with an other device, which antenna (2,3) comprises two elements (21,22), first outer ends of the elements (21,22) being coupled to each other and second outer ends of the elements (21,22) being coupled to each other, each element (21,22) comprising two sub-elements (23,24,25,26) separated by a gap (27,28), the elements (21,22) having lengths smaller than half the wavelength of the radio frequency signals.

2. Device (1) according to claim 1, wherein the elements (21,22) are parallel elements, the length of an element (21,22) having a value between 40% and 80% of half the wavelength of the radio frequency signals and a width of an element (21,22) having a value between 0.1% and 20% of the length, a gap distance of an element (21,22) having a value smaller than 20% of the length, and an element distance between the parallel elements (21,22) having a value between 0.1% and 20% of the length.

3. Device (1) according to claim 1, wherein the antenna (2,3) does not operate against a ground surface.

4. Device (1) according to claim 1, wherein the elements (21,22) are planar elements, the outer ends of the elements (21,22) being coupled to each other via other planar elements (29,30).

5. Device (1) according to claim 1, wherein the antenna (2,3) comprises two further elements (41,42), first outer ends of the further elements (41,42) being coupled to each other and second outer ends of the further elements (41,42) being coupled to each other, the further elements (41,42) having lengths smaller than half the wavelength of the radio frequency signals.

6. Device (1) according to claim 5, wherein the two elements (21,22) are planar elements printed on a first side of a circuit board and the two further elements (41,42) are further planar elements printed on a second side of the circuit board.

7. Device (1) according to claim 6, wherein the elements (21,22) are parallel elements and the further elements (41,42) are parallel further elements, the length of an element (21,22,41,42) having a value between 40% and 80% of half the wavelength of the radio frequency signals and a width of an element (21,22,41,42) having a value between 0.1% and 20% of the length, a gap distance of an element (21,22,41,42) having a value smaller than 20% of the length, an element distance between the parallel elements (21,22) and between the parallel further elements (41,42) having a value between 0.1% and 20% of the length, a thickness of the elements (21,22,41,42) having a value equal to or smaller than 10% of the width, and the circuit board comprising a substrate material with a thickness having a value equal to or smaller than the width.

8. Device (1) according to claim 5, wherein one of the further elements (41) comprises two sub-elements (43,44) separated by a gap (47) diagonally opposite to a feeding gap (28) of the elements (21,22), the other further element (42) being without a gap.

9. Device (1) according to claim 8, wherein a gap distance of the gap (47) between the two sub-elements (43,44) of the further element (41) has a value smaller than 20% of at least one length.

10. Device (1) according to claim 5, wherein one of the further elements (42) comprises two sub-elements separated by a gap non-diagonally opposite to a feeding gap (28) of the elements (21,22), the other further element (41) being without a gap.

11. Antenna (2,3) for exchanging radio frequency signals, which antenna (2,3) comprises two elements (21,22), first outer ends of the elements (21,22) being coupled to each other and second outer ends of the elements (21,22) being coupled to each other, each element (21,22) comprising two sub-elements (23,24,25,26) separated by a gap (27,28), the elements (21,22) having lengths smaller than half the wavelength of the radio frequency signals.

12. Method for exchanging radio frequency signals and comprising the step of using an antenna (2,3), which antenna (2,3) comprises two elements (21,22), first outer ends of the elements (21,22) being coupled to each other and second outer ends of the elements (21,22) being coupled to each other, each element (21,22) comprising two sub-elements (23,24,25,26) separated by a gap (27,28), the elements (21,22) having lengths smaller than half the wavelength of the radio frequency signals.
